(19) United States
(12) Patent Application Publication
(10) Pub. No.: US 2023/0192917 A1
(43) Pub. Date: Jun. 22, 2023

(54) COMPOSITIONS AND METHODS OF MAKING TILES FROM PLASTIC WASTE

(71) Applicant: Coldharbour Tiles Inc., West Newton, MA (US)

(72) Inventor: Emily E. Packer, Berlin (DE)

(73) Assignee: Coldharbour Tiles Inc., West Newton, MA (US)

(21) Appl. No.: 18/069,629

(22) Filed: Dec. 21, 2022

Related U.S. Application Data
(60) Provisional application No. 63/292,084, filed on Dec. 21, 2021.

(51) Int. Cl. C08F 110/02; C08K 3/22; C08K 5/521; C08K 3/34; C08F 110/06

(52) U.S. Cl. CPC C08F 110/02; C08K 3/22; C08K 5/521; C08K 3/346; C08F 110/06; C08K 2003/2224; C08F 2500/08

(57) ABSTRACT

The present disclosure provides compositions comprising a tile and methods for preparing the tile. The tile may be a floor tile, a wall tile, or a decorative tile used commercially or residentially.

### CROSS-REFERENCE TO RELATED APPLICATION

This application claims benefit of U.S. Provisional Patent Application No. 63/292,084, which was filed in the U.S. Patent and Trademark Office on Dec. 21, 2021, the entire contents of which are incorporated herein by reference for all purposes.

### FIELD OF THE DISCLOSURE

The present disclosure relates to recycled polymer (plastic) sheet compositions and method of making recycled polymer sheet compositions into articles such as floor tiles from polymer waste (i.e., plastic recycling). The compositions provide tiles which possess low flammability, high ultraviolet (UV) stability, high durability, long term thermal stability, extended shelf life, no loss of gloss, a non-plastic appearance, and other attributes.

### BACKGROUND OF THE INVENTION

Plastic recycling (polymer recycling) is the reprocessing of various forms of plastic waste into new products. It is estimated that there is about 8.3 billion tons of plastic waste worldwide. Each year, it is estimated that more than 400 million tons of plastic waste is produced. The plastic waste may come from industrial scrap or from post-consumer scrap. Much of the plastic waste is present in landfills but is also found in waterways (oceans, lakes, rivers, etc.). The presence of plastic waste is not appealing, the plastic waste does not degrade, and may be a vital source of raw materials which may be used in reprocessing.

Although plastics were known before the 20th century, large-scale production was not realized until WWII. With metal supplies allocated towards military use and an increased demand for high-performance materials, these untested synthetic alternatives became appealing. Nylon replaced silk in parachutes, while Perspex was a light-weight alternative to glass in airplanes. After the war, these processes were commercialized rapidly, with the plastic age beginning from around 1950, greatly aided by the post WWII war economic boom.

In the last four decades, methods for recycling plastic waste have grown. Products prepared from recycled plastics include, but are not limited to, shampoo bottles, detergent bottles, traffic cones, trash bags, countertops, and carpeting. These products are generally prepared by melting and reforming the plastic waste or chemically depolymerizing the plastic recycled plastic waste. Waste obtained from plastic recycling may include but not limited to organic waste, metal waste, water waste, and increased levels of carbon dioxide and other gases released into the environment and can be substantial depending upon the method of recycling the plastic waste. The waste from these methods may be substantial.

Recent endeavors have examined the use of plastic recyclates, but never in tile compositions. Plastic recyclates are fibers generated from plastic waste and are easily prepared by grinding the waste. What is needed are methods and compositions comprising plastic recyclates, in particular tile compositions comprising plastic recyclates and/or plastic regrind. What is also needed are novel tile compositions (e.g., comprising plastic regrind) which possess low flammability, high ultraviolet (UV) stability, high durability, long term thermal stability, extended shelf life, provide a low environmental impact, reuse the polymer waste, and are easily prepared.

What is needed are methods and composition which produce products which possess low flammability, high ultraviolet (UV) stability, high durability, long term thermal stability, extended shelf life, provide a low environmental impact, reuse the polymer waste, and are easily prepared.

### FIGURES

FIG. 1 is a color photograph showing a HDPE floor tile prepared using recycles HDPE.

FIG. 2 is a color photograph showing a HDPE floor tile with two different colors.

FIG. 3 is a color photograph showing the front of a blue tile, the surface appearance resulting from powder.

FIG. 4 is a color photograph showing a tile manufactured from regrind of industrial scrap.

FIG. 5 is a color photograph showing a first example of indoor use.

FIG. 6 is a color photograph showing a second example of indoor use.

### SUMMARY OF THE INVENTION

In one aspect, disclosed herein, there are provided tile compositions comprising: (a) at least about 40 wt. % of recycled polymer; and (b) at least one additive including a mold releasing additive; wherein the composition comprises polypropylene, polyethylene, or a combination thereof and wherein the composition comprises 0 wt. % of virgin polymer.

In a preferred embodiment, disclosed herein, there are provided tile compositions comprising: (a) at least 40 wt. % of recycled polymer and (b) at least one additive including a mold releasing additive; wherein the recycled polymer comprises high density polyethylene (HDPE), low density polyethylene (LDPE), polypropylene, or a combination thereof and wherein the composition comprises 0 wt. % of virgin polymer.

Other features and iterations of the invention are described in more detail below.

### DETAILED DESCRIPTION OF THE INVENTION

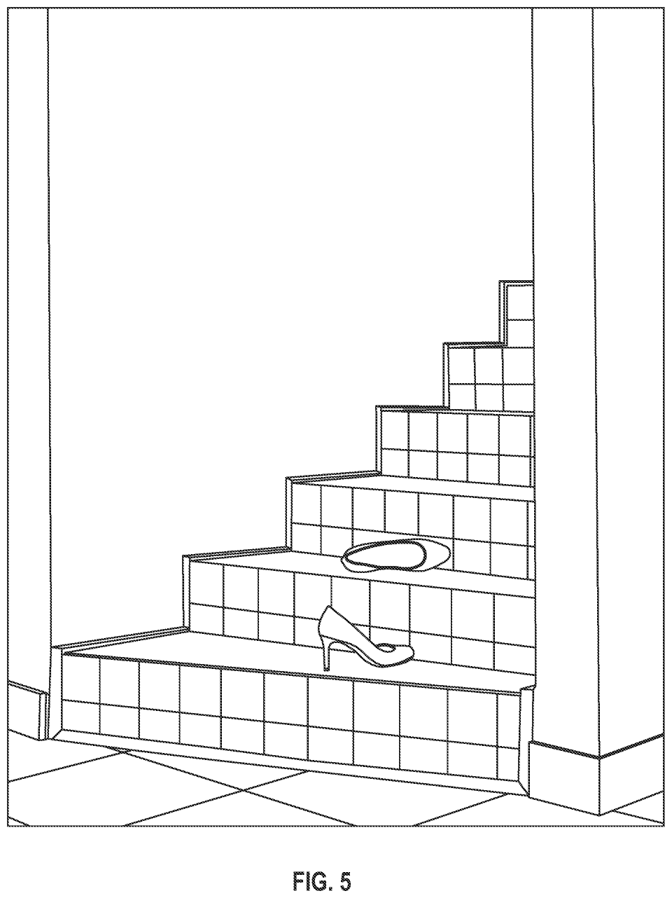

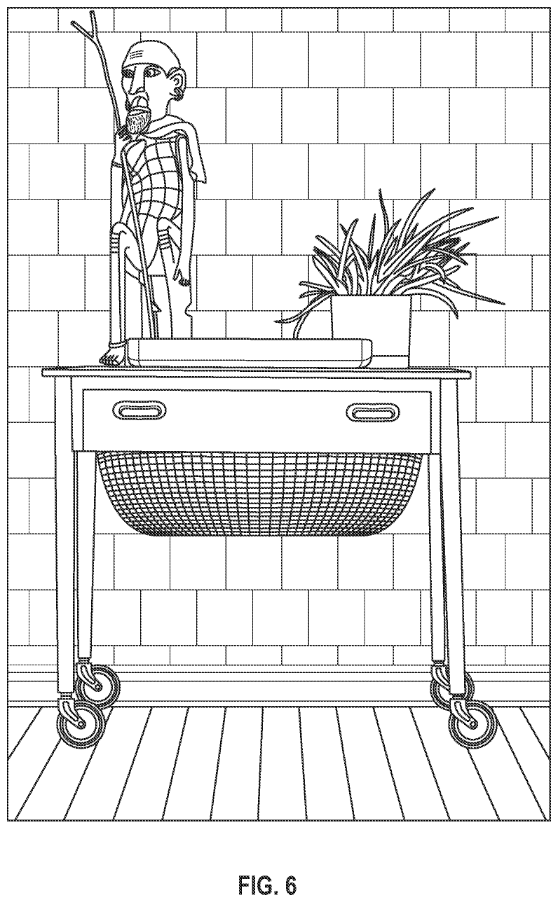

The present disclosure encompasses tile compositions, in the following also termed compositions comprising a tile. The tile compositions comprising: (a) at least about 40 weight % (wt. %) of a recycled polymer; and (b) at least one additive including a mold releasing additive; wherein the (recycled) polymer comprises polypropylene, polyethylene, or a combination thereof and wherein the composition comprises 0 wt. % of virgin polymer. The virgin polymer, as defined herein, are polymers that are directly prepared from monomers, dimers, co-polymers, homopolymers, etc. that are polymerized to form a polymer from a manufacturing establishment and used directly in the tile, not recycled. The tile, as disclosed herein, includes a floor tile, a wall tile, a decorative tile that may be used in indoor applications (see FIGS. 5 and 6), outdoor applications, or both applications and may be used in a residential and/or commercial application. The tile may be of various shapes such as a rectangle, a square, an oval, or a circle. The tile possesses a color that originally is derived from the recycled polymer such as green, red, or colorless. The color of the tile may be modified to meet the customer's needs and desires. The tile is aesthetically pleasing providing a grainy, textured, and non-plastic appearance.

The tile may be about 1 mm to about 10 mm in thickness, from about 1 mm to about 7 mm in thickness, from about 1 mm to about 5 mm in thickness, from about 1 mm to about 3 mm in thickness, or from about 1 mm to about 2 mm in thickness. The tile may comprise a plurality of layers (e.g., two layers, three layers, four layers, five layers, six layers, . . . n layers). Each layer may be about 1 mm to about 10 mm in thickness, from about 1 mm to about 7 mm in thickness, from about 1 mm to about 5 mm in thickness, from about 1 mm to about 3 mm in thickness, from about 1 mm to about 2 mm in thickness, from about 0.5 mm to about 1 mm in thickness.

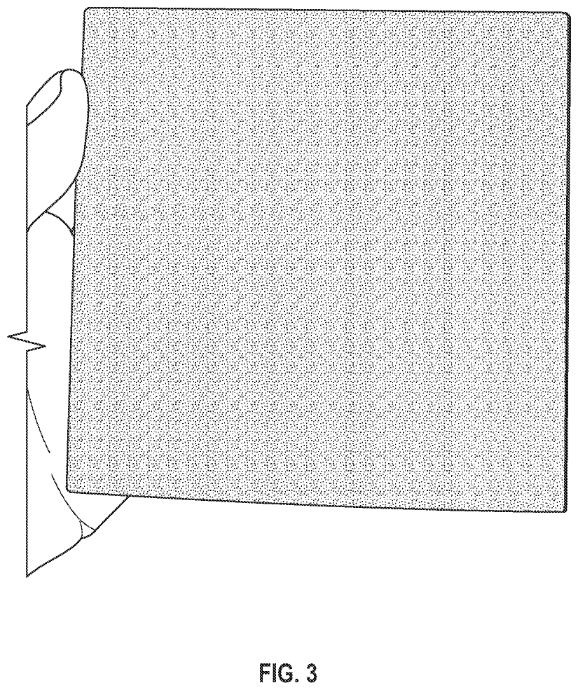

Methods to prepare these tiles (unpigmented or pigmented tiles) are described in more detail below. The tiles are easily prepared, provide a low environmental foot print on the environment, have minimal waste, contain no virgin polymer, and may be pigmented to a variety of colors (see FIG. 3).

### I. Tile Compositions

Described herein are tile compositions. In various embodiments, the tile compositions described herein comprise at least 40 wt. % of a recycled polymer and at least one additive including a mold releasing additive wherein the polymer comprises polyethylene, polypropylene, or a combination thereof and wherein the polymer comprises 0 wt. % of virgin polymer. In other embodiments, the tile composition described herein comprise at least 40 wt. % of a recycled polymer and at least one additive wherein the polymer comprises high density polyethylene (HDPE), low density polyethylene (LDPE), polypropylene, or a combination thereof and the polymer comprises 0 wt. % of virgin polymer.

The at least one additive further comprises may be at least one light stabilizer, at least one flame retardant, a stabilizer additive, or a combination thereof.

Generally, the at least one flame retardant, at least one stabilizer additive, at least one mold releasing additive, or a combination thereof may comprise from about 1 wt. % to about 70 wt. % of the composition. In various embodiments, the at least one flame retardant, at least one stabilizer additive, at least one mold releasing additive, or a combination thereof may comprise from about 1 wt. % to about 70 wt. % of the composition, from about 0.1 wt. % to about 10 wt. %, from about 10 wt. % to about 20 wt. %, from about 20 wt. % to about 30 wt. %, from about 30 wt. % to about 40 wt. %, from about 40 wt. % to about 50 wt. %, from about 50 wt. % to about 60 wt. %, or from about 60 wt. % to about 70 wt. %.

The further additive in the tile composition may be one additive, two additives, three additives, four additive, or more than 4 additives.

(a) At Least One Recycled Polymer

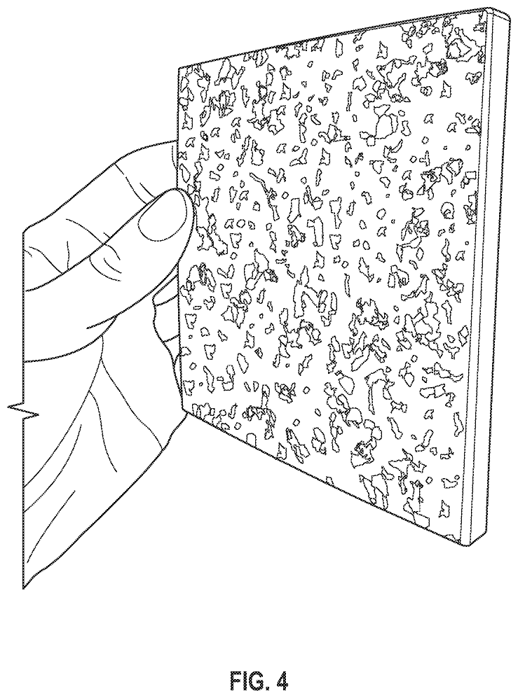

The tile composition includes at least one recycled polymer. The at least one recycled polymer may be a waste from industrial scrap (see FIG. 4), post-consumer scrap, or a combination thereof and does not contain any virgin polymer. The at least one recycled polymer scrap may be initially clean before introduction into the recycled polymer composition. Cleaning the recycled polymer (post-consumer waste) comprises removing unneeded debris from the interior and external surface of the plastic article, cleaning the interior and external with a cleaning solution such as a detergent and water, rinsing the interior and external surfaces of the recycled polymer source with water, and drying the recycled polymer source. The industrial scrap from a polymer manufacturing process may be also sorted and cleaned. Sorting the industrial scrap comprises sorting the waste according to type, size, color, and optionally cleaning such waste. The waste may be further dried to ensure the excess moisture is removed from the industrial waste. In one embodiment, the at least one recycled polymer is industrial scrap. In another embodiment, the at least one recycles polymer is post-consumer waste.

The type of recycled polymer is important for the tile composition. In various embodiments, the at least one recycled polymer is selected from a group consisting of polyethylene (PE), polypropylene (PP), or a combination thereof. The at least one recycled polymer comprises 0 wt. % of virgin polymer. In other embodiments, the at least one recycled polymer comprises high-density polyethylene (HDPE), low-density polyethylene (LDPE), polypropylene (PP), or a combination thereof wherein the polymer comprises 0 wt. % of virgin polymer. In one embodiment, the at least one recycled polymer is high-density polyethylene. In another embodiment, the at least one recycled polymer is low-density polyethylene. In yet another embodiment, the at least one recycled polymer is polypropylene.

After obtaining the recycled polymer source from a polymer recycling facility or a polymer manufacturing process, the recycled polymer source is initially sorted and shredded. The shredded polymer is directly obtained from the sorted and cleaned recycled polymer. The shredded polymer is then further transformed into a granule form (termed as “plastic regrind”) or a pellet form to a consistency which is usable in the recycled polymer composition.

The shredded polymer comes in various shapes having a jagged edge appearance or a smooth edge appearance. The shredded polymer may be further processed into a regrind that is more usable in preparing composition comprising a tile such as a hard ball-shaped appearance or a tube-shaped appearance.

In general, the shredded polymer has a size ranging from about 1 mm to about 5 mm. In various embodiments, the shredded polymer has a size ranging from about 1 mm to about 5 mm, from about 1 mm to about 2 mm, from about 2 mm to about 3 mm, from about 3 mm to about 4 mm, or from about 4 mm to about 5 mm.

Generally, the plastic regrind has a size ranging from about 1 mm to about 5 mm, from about 1 mm to about 2 mm, from about 2 mm to about 3 mm, from about 3 mm to about 4 mm, or from about 4 mm to about 5 mm. In one embodiment, the plastic regrind has a size ranging from about 2 mm to about 5 mm.

In general, the tile composition is at least 40 wt. % recycled polymer. In various embodiments, the tile composition is at least 40 wt. % recycled polymer, at least 50 wt. %, at least 60 wt. %, at least 70 wt. %, at least 80 wt. %, at least 90 wt. %, or greater than 90 wt. %.

Generally, the tile composition comprises about 40 wt. % to about 95 wt. % of the at least one recycles polymer. In various embodiments, the composition comprising a tile comprises about 40 wt. % to about 95 wt. %, about 50 wt. % to about 90 wt. %, from about 40 wt. % to about 45 wt. %, from about 45 wt. % to about 50 wt. %, from about 50 wt. % to about 55 wt. %, from about 55 wt. % to about 60 wt. %, from about 60 wt. % to about 65 wt. %, from about 65 wt. % to about 70 wt. %, from about 70 wt. % to about 75 wt. %, from about 75 wt. % to about 80 wt. %, from about 80 wt. % to about 85 wt. %, from about 85 wt. % to about 90 wt. %, or from about 90 wt. % to about 95 wt. %.

(b) At Least One Flame Retardant

The composition (e.g., comprising a tile) may comprise at least one flame retardant, such as a halogen free flame retardant. The at least one flame retardant and/or halogen free flame retardant may comprise a sepiolite clay, a metal phosphate flame retardant, a modified alkali earth hydroxide flame retardant, or a combination thereof. A variety of sepiolite clays may be used in the recycled polymer composition as a flame retardant. Sepiolate clays are a complex magnesium silicate, typically having a chemical formula of Mg₄Si₆O₁₅(OH)₂·6H₂O, and may be present in fibrous, fine-particulate, needle form, and solid forms. These sepiolite clays may be unmodified or modified with various polymer additives or organic additives such as quaternary ammonium salts. In one embodiment, the sepiolite clay may be a high purity, organic modified with quaternary ammonium salts. This sepiolite clay useful in the recycled polymer composition may be Adins Clay 20 by Tolsa. These modified sepiolite clays are known to reduce smoke, reduce char formation, and significantly reduce heat release that will prevent second burns, when used in combination with other flame retardants.

The at least one flame retardant and/or halogen free flame retardants may also be an unmodified or modified alkali earth hydroxide with a polymeric surface treatment. These modified alkali earth hydroxides are selected from a group consisting of aluminum trihydroxide, magnesium dihydroxide, antimony trioxide, and combinations thereof. In other embodiments, the modified alkali earth hydroxide is Magnifin H5-GV TM from Huber Materials which is a modified magnesium dihydroxide with a polymeric surface treatment.

The at least one flame retardant may be a phosphate flame retardant either bound to a metal, an organic molecule (an organophosphorus compound), or organometal phosphate compound. These phosphate flame retardants are considered halogen-free flame retardants. The metal phosphate flame retardant may also be a multicomponent molecule. A wide range of metal phosphate flame retardants may be used the composition. Non-limiting examples of halogen free flame retardants may be organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate and melamine polyzinc phosphate. In still other embodiments, the halogen free phosphate flame retardant used in the pigmented or unpigmented recycled polymer sheet may be a melamine poly(zinc phosphate) known as Safire 400 TM by Huber Materials. This flame retardant has been proven to be efficient synergists for use with other conventional flame retardant.

In other embodiments, the at least one flame retardant may be a combination of two or more flame retardants. In one embodiment, the at least one flame retardant may be a combination of Magnifin H5-GV, Adins Clay 20, and Safire 400.

In general, the at least one flame retardant and/or halogen free flame retardants suitable in the tile composition may range from about 0.1 wt. % to about 50 wt. %. In various embodiments, the at least one halogen free flame retardant ranges from about 0.1 wt. % to about 50 wt. %, from about 0.1 wt. % to about 10 wt. %, from about 10 wt. % to about 20 wt. %, from about 20 wt. % to about 30 wt. %, from about 30 wt. % to about 40 wt. %, or from about 40 wt. % to about 50 wt. %. In one embodiment, the at least one halogen free flame retardant suitable in the tile composition may range from about 0.5 wt. % to about 30 wt. %

(c) At Least One Light Stabilizer

The tile composition may comprise at least one light stabilizer which are considered hindered amine light stabilizer (HALS) or a substituted benzophenone light stabilizer. The at least one light stabilizer included into the tile composition provides long term stability, long term UV light stabilization, and other benefits. The at least one light stabilizer comprises a low molecular weight hindered amine light stabilizer, a high molecular weight hindered amine light stabilizer, a 2-hydroxy-substituted benzophenone light stabilizer, or a combination thereof.

The at least one light stabilizer are chemical compounds containing an amine functional group or an organic benzophenone group that are also used as stabilizers in plastics and polymers. These compounds are typically derivatives of tetramethylpiperidine or benzophenone and are primarily used to protect the polymers from the effects of photo-oxidation; as opposed to other forms of polymer degradation such as ozonolysis. The use of a hindered amine or benzophenone possessing no alpha-hydrogens prevents the HALS from being in an intramolecular Cope reaction. In commercial applications, the HALS have a reactive piperidine or benzophenone group which is usually bonded to bulky chemical scaffold, in order to reduce its volatility during the melt processing of plastic.

The at least one light stabilizer may comprise a low molecular weight hindered amine light stabilizer. In general, the low molecular weight hindered amine light stabilizer generally have a molecular weight range from about 200 g/mole to about 500 g/mole and have a piperidine functional group in the chemical structure. These low molecular weight light stabilizers provide increased light stability in thick sections and high surface area of prepared polymer. In various embodiments, the useful low molecular weight hindered amine light stabilizer is N,N′-bis(2,2,6,6-tetramethyl piperidyl)-N, N′-diformylhexamethylenediamine referred to as Univul 4050 by BASF.

The at least one light stabilizer may comprise a high molecular weight hindered amine light stabilizer. The high molecular weight hindered amine stabilizer provide improved polymer capability, resistance to UV light, long term thermal stability, and other ancillary properties such as minimal pigment interaction and improved melt flow control. Generally, the high molecular weight hindered amine light stabilizer have a molecular weight ranging from about 2,000 g/mol or higher than 2,000 g/mol and have one or more piperidine functional groups and a triazole in the chemical structure. In various embodiments, the useful high molecular weight hindered amine stabilizer is 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine by BASF.

The at least one light stabilizer may comprise a 2-hydroxy-substituted benzophenone light stabilizer. 2-Hydroxy-substituted benzophenones are a class of compounds which are known as UV blockers which reduce the failure of polymers due exposure to sunlight including discoloration (yellowing), cracking, and loss of adhesion. In various embodiments, the at least one light stabilizer comprises 2-hydroxy-4-(n-octyloxy)benzophenone.

In other embodiments, two or more light stabilizers may be used in the composition. The skilled artisan readily understands that 2-hydroxy-substituted benzophenone derivatives are light stabilizers and low and high molecular weight hindered amine stabilizers provide a synergistic effect through carbonyl stabilization by the amine. In one embodiment, the at least one light stabilizer comprises a mixture of N,N′-bis(2,2,6,6-tetramethyl-4-piperidyl)-N,N′-diformylhexamethylenediamine, 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, and 2-hydroxy-4-(n-octyloxy)benzophenone. In another embodiment, the at least one light stabilizer comprises a mixture of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine and 2-hydroxy-4-(n-octyloxy)benzophenone.

Generally, the amount of the at least one light stabilizer in the tile composition may range from 0.005 wt. % to about 10 wt. % of the composition. In various embodiments, the amount of the at least one light stabilizer in the tile composition may range from 0.005 wt. % to about 10 wt. %, from about 0.005 wt. % to about 0.1 wt. %, from 0.1 wt. % to about 1 wt. %, from about 1 wt. % to about 2 wt. %, from about 2 wt. % to about 3 wt. %, from about 3 wt. % to about 4 wt. %, or from about 4 wt. % to about 5 wt. %, from about 6 wt. %, from about 6 wt. % to about 7 wt. %, from about 7 wt. % to about 8 wt. %, from about 8 wt. % to about 9 wt. %, or from about 9 wt. % to about 10 wt. %. In one embodiment, the amount of the at least one light stabilizer in the tile composition may range from about 0.1 wt. % to about 6 wt. %. In another embodiment, the amount of the at least one light stabilizer in the tile composition may range from about 0.1 wt. % to about 9 wt. %.

(d) Stabilizer Additive

The tile composition may comprise a stabilizer additive. The stabilizer additive improves the durability of the tile, extends the life of the tile, and may be utilized in recycled HDPE, LDPE, PP, and mixtures of polymers and/or recyclates of such polymers. The stabilizer additive may a single additive or a mixture of stabilizer additives. In one embodiment, the stabilizer additive may be IngraCycle 30G which is a proprietary mixture of stabilizers from BASF.

In general, the stabilizer additive may range from 0.005 wt. % to about 5 wt. %. In various embodiments, the stabilizer additive may range from 0.005 wt. % to about 5 wt. %, from about 0.005 wt. % to about 0.1 wt. %, from about 0.1 wt. % to about 1 wt. %, from 1 wt. % to about 2 wt. %, from about 2 wt. % to about 3 wt. %, from about 3 wt. % to about 4 wt. %, or from about 4 wt. % to about 5 wt. %.

(e) Mold Releasing Additive

The tile composition may comprise a mold releasing additive. The mold releasing additive is designed to improve the injection molding process by reducing friction, allowing more efficient processing, and allowing for the efficient release of the article from the internal mold. The mold releasing agent provides additional benefits such as an anti-scratch surface and with a low loading in the tile composition, there are no detrimental effects on the mechanical properties. In one embodiment, the mold releasing additive in the tile composition is IncroMold K™ by Croda.

Generally, the mold releasing additive may range from 0.005 wt. % to about 5 wt. % of the composition. In various embodiments, the mold releasing additive may range from 0.005 wt. % to about 5 wt. %, from about 0.005 wt. % to about 0.1 wt. %, from about 0.1 wt. % to about 1 wt. %, from 1 wt. % to about 2 wt. %, from about 2 wt. % to about 3 wt. %, from about 3 wt. % to about 4 wt. %, or from about 4 wt. % to about 5 wt. % of the composition.

(f) At Least One Pigment

The tile composition may be further pigmented (colored). The coloring of the tile composition may be requested by the customer or to produce the desired article, such as a floor tile, wall tile, or decorative tile in the desired color.

The at least one pigment may be added to the tile composition. The at least one pigment may comprise one, two, three, four, or more pigments added to the unpigmented tile composition to form the desired color. The at least one pigment may be a pigment masterbatch. The pigment masterbatch comprises the at least one pigment and the tile composition. The components in the composition do not affect the long-term stability nor degrade the color of the article. Non-limiting examples of suitable pigments for these tile compositions may be a purple pigment such as aluminum pigments (ultramarine violet), copper pigments (Han's purple), cobalt pigments (cobalt violet), manganese pigments (magnesium violet), and gold pigments (Purple of Casius); a blue pigment such as aluminum pigments (Ultramarine blue and Persian Blue), Cobalt pigments (Cobalt blue and Cerulean blue), copper pigments (Egyptian blue, Han blue, azurite, and basic copper carbonate), iron pigments (Prussian blue), manganese pigments (TInMn blue and magnesium blue); green pigments such as cadmium pigments (cadmium green), chromium pigments (chrome green and Viridian), cobalt pigments (cobalt green), copper pigments (malachite and Scheele's green) ad Green earth; yellow pigments such as arsenic pigments (orpiment), bismuth pigments (primrose yellow), cadmium pigments (cadmium yellow), chromium pigments (chrom yellow or crocoite), cobalt pigments (Aureolin or cobalt yellow), iron pigments (yellow ochre, lead pigments (Naples yellow or lead-tin yellow), titanium pigments (titanium yellow), tin pigments (mosaic gold), and zinc pigments (zinc yellow); orange pigments such as bismuth pigments (bismuth vanadate orange), cadmium pigments (cadmium orange), and chromium pigments (chrom orange); red pigments such as arsenic pigments (realgar), cadmium pigments (cadmium red), cerium pigments (cerium sulfide red), iron pigments (red ochre and burnt sienna), and lead pigments (minimum); brown pigments which are naturally forms of iron oxide such as raw umber and raw sienna; black pigments such as carbon pigments (carbon black, ivory black, vane black, and lamp black), iron pigments (Mars black), magnesium pigments (magnesium dioxide), and titanium pigments (titanium black); white pigments such as antimony pigments (antimony white), barium pigments (barium sulfate or lithopone), lead pigments (Cremnitz white)titanium pigments (titanium white) and zinc pigments (zinc white and Sachtolith).

In another embodiment, the pigment may be considered an alternative to titanium oxide. Various alternatives to titanium oxide are known in the art such as kaolin, rice starches, and rice flour.

Generally, the amount of the at least one pigment added to the tile composition may range from about 10 wt. % to about 30 wt. %. In various embodiments, the amount of the at least one pigment added to the tile composition may range from about 10 wt. % to about 30 wt. %, from about 10 wt. % to about 12 wt. %, from about 12 wt. % to about 14 wt. %, from about 14 wt. % to about 16 wt. %, from about 16 wt. % to about 18 wt. %, from about 18 wt. % to about 20 wt. %, from about 20 wt. % to about 22 wt. %, from about 22 wt. % to about 24 wt. %, from about 24 wt. % to about 26 wt %, from about 26 wt. % to about 28 wt. %, or from about 28 wt. % to about 30 wt. %. In one embodiment, the amount of the at least one pigment added to the tile composition may be about 20 wt. %.

(g) The at Least One Additive Comprising a Stabilizer Additive, a Mold Releasing Additive, or a Combination Thereof

The individual additives are described in more detail above. In another embodiment, the at least one additive comprises a stabilizer additive, a mold releasing additive, or a combination thereof.

Generally, the at least one additive comprises a stabilizer additive, a mold releasing additive, or a combination thereof may range from 0.1 wt. % to about 8 wt. %. In various embodiments, the at least one additive comprises a stabilizer additive, a mold releasing additive, or a combination thereof may range from 0.1 wt. % to about 8 wt. %, from about 0.1 wt. % to about 1 wt. %, from about 1 wt. % to about 2 wt. %, from about 2 wt. % to about 3 wt. %, from about 3 wt. % to about 4 wt. %, from about 4 wt. % to about 5 wt. %, from about 5 wt. % to about 6 wt. %, from about 6 wt. %, to about 7 wt. %, or from about 7 wt. % to about 8 wt. %. In one embodiment, the at least one additive comprises a stabilizer additive, a mold releasing additive, or a combination thereof may range from 0.1 wt. % to about 6 wt. %.

(h) Optional Coating

The tile composition may further comprise an anti-scratch and transparent coating. The coating may additionally provide increased scratch and abrasion resistance, increased chemical resistance, and no deferential effects on the tile such as curling. These coatings are generally a lacquer, a mixture of lacquers, a polyurethane coating, an epoxy coating, an acrylic coating for example. Various coatings for tiles, in a commercial or residential setting are known in the art.

(i) Properties of the Composition Comprising a Tile

The tile composition may have some unique properties. Since the composition comprises at least one recycled polymer, the composition retains the mechanical properties of the at least one recycled polymer used in preparing the tile composition. Some of these attributes are low flammability, high ultraviolet (UV) stability, high durability, long term thermal stability, extended shelf life, and non-plastic appearance.

Additionally, the tile composition's color is dependent on the source of the at least one recycled polymer from the manufacturing process. Generally, the color of the at least one recycled polymer may be colorless, a greenish color, a bluish color, or a reddish color. Yet, a small amount of the at least one recycled polymer of a color nature may change the color change to the recycled polymer composition.

Also, the tile composition may comprise a compressed powder.

The tile composition may comprise particle, particulates, pellets, and/or a powder. The size of these particles, particulates, pellets, and/or a powder may provide the tile with a unique appearance such as grainy appearance.

In general, the size of these particles, particulates, pellets, and/or a powder is from about 1 mm to about 10 mm. In various embodiments, the size of these particles, particulates, pellets, and/or a powder is from about 1 mm to about 10 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm, or from about 9 mm to about 10 mm. In one embodiment, the size of these particles, particulates, pellets, and/or a powder is from about 1 mm to about 5 mm.

Generally, the size of these particles, particulates, pellets, and/or a powder is less than 600 microns in size. In various embodiments, the size of these particles, particulates, pellets, and/or a powder is less than 600 microns in size, less than 500 microns in size, less than 400 microns in size, less than 300 microns in size, less than 200 microns in size, or less than 100 microns in size. In one embodiment, the size of these particles, particulates, pellets, and/or a powder is less than 200 microns in size.

In general, the tile composition has a surface tension of at least about 40 mN/m or higher. In various embodiments, the tile composition has a surface tension of at least about 40 mN/m or higher, of at least 45 nN/m or higher, of at least 50 nN/m or higher, or greater than 50 nN/m.

### II. Method for Preparing the Tile Composition

Another aspect of the present disclosure relates to methods for preparing the tile composition.

A. Method Forming a Tile Composition

The method for preparing the tile composition comprises: (a) contacting a polymer regrind of the at least one recycled polymer, the at least one flame retardant, the at least one light stabilizer, a stabilizer additive, and the mold releasing additive forming a mixture; (b) compounding the mixture from step (a); (c) heating and extruding the compounded mixture; (d) milling the extruded mixture of the pellets, particulates, and powders into a powder; (e) forming a tile from the pellets, particulates, and the powder; and (f) applying an optional coating. The method for preparing a tile composition may further comprise at least one pigment or a pigment master batch.

(a) Contacting the at Least One Recycled Polymer, the at Least One Flame Retardant, the at Least One Light Stabilizer, a Stabilizer Additive, and the Mold Releasing Additive Forming a Mixture

The method for preparing the tile composition commences by contacting the at least one polymer regrind of the at least one recycled polymer, the at least one flame retardant, the at least one light stabilizer, a stabilizer additive, and the mold releasing additive forming a mixture. The at least one recycled polymer regrind, the at least one flame retardant, the at least one light stabilizer, a stabilizer additive, and the mold releasing additive are described in more detail above.

The at least one recycled polymer is initially obtained as industrial scrap from a polymer manufacturer. The scrap may be sorted and optionally cleaned. Sorting the industrial scrap comprises sorting the industrial scrap by type and color. The sorted industrial scrap is then shredded. The shredded recycled polymer is about 1 mm to about 5 mm in size and has a jagged-edge appearance and is then converted into a regrind. This regrind is converted into pellets having a 2 mm to 5 mm size which are bell shaped or tube-shaped polymer. The components of the mixture may be added in any sequential order, in various portions, or entirely at once. An inert atmosphere such as helium, nitrogen, argon, or combinations thereof may be utilized.

(b) Compounding the Mixture from Step (a)

The next step in the method comprises compounding the mixture from step (a). During this compounding step, the mixture of the components of the is compounded using methods known in the art using a single screw or a double screw compounding equipment.

(c) Heating and Extruding the Compounded Mixture into Pellets and Micropellets

The next step in the method comprises heating and extruding the compounded mixture. This method step prepares a malleable pre-composite by melting the compounded mixture at an elevated temperature. Heating the compounded mixture may be conducted under an inert atmosphere such as helium, nitrogen, argon, or a combination thereof.

Generally, heating the compounded mixture may be conducted at a temperature may range from about 150° C. to 250° C. In various embodiments, the temperature of heating the compounded mixture may range from about 150° C. to about 250° C., from about 150° C. to about 170° C., from about 170° C. to about 190° C., from about 190° C. to about 210° C., from about 210° C. to about 230° C. or from about 230° C. to about 250° C. In one embodiment, the temperature of heating the compounded mixture of the unpigmented recycled polymer composition may range from about 180° C. to 240° C.

In general, the duration of heating the compounded mixture may range from about 30 seconds to about 1 hour. In various embodiments, the duration of heating the compounded mixture from step (e) may range from about 30 seconds to about 1 hour, from about 1 minute to about 45 minutes, or from about 15 minutes to about 30 minutes. In one embodiment, the duration of heating the compounded mixture is about 15 minutes.

After the mixture is heated, the heated mixture is extruded. The extruded mixture may be in various forms. The extruded mixture may be in the form of micropellets, pellets, particulates, and/or powders.

(d) Milling the Extruded Mixture Forming a Recycled Polymer Powder Composition

The next step in the method comprises milling the micropellets, pellets, particulates, and/or powders from the extruded mixture into a powder having a size 600 microns or less. Methods and equipment for milling polymers and polymer mixtures are known in the art.

The size of the powder from the milling is less than about 600 microns. In various embodiments, the size of the powder composition is less than about 600 microns, less than about 500 microns, less than about 400 microns, less than about 300 microns, less than about 200 microns, or less than 100 microns.

(e) Forming a Tile.

The next step in the method is forming the tile. This step comprises converting the powder into a tile using methods known in the art such as compression molding or injection molding. Various methods and parameter are known in the art.

B. Method for Preparing the Tile Composition with Different Colored Layers.

The method also encompasses methods for preparing a tile composition with two different colored layers. The method also encompasses a multi-layered tile composition. The method comprises: (a) introducing a milled composition comprising at least one pigment into a mold; (b) molding, laminating, or compressing the pellets into the mold forming a tile; (c) cooling the tile as a sheet for a film; (d) introducing onto a surface of the milled composition that does not comprise at least one pigment a milled composition in a mold; (e) forming tile in the mold; (f) cooling the tile; and (g) applying a transparent, anti-scratch coating to the surface of the tile.

Milled Compositions

The milled compositions are described in more detail above.

Compression molding may be used to form the tile. Initially, a tile is formed within a mold by compression molding of the milled composition at least one pigment. The first layer is compressed forming a sheet or a film. Then, a second milled composition which does not contain a pigment is introduced on top of the and molded on top of the initial compressed composition. The mold is clamped, the layers are compressed together. After cooling to prevent warping, the tile with two different colors is formed.

Injection molding may also be used to form the tile. Initially, the first layer is formed into the mold using injection molding as a sheet or a film. The first layer may be the composition with at least one pigment. A second layer comprising the milled composition that does not comprising a pigment can then be injected on top of the first layer using injection molding. The mold is heated once again to ensure the two layers are bounded together and no air bubbles are present. Upon cooling, the tile with two different colors is formed.

Another method for forming the multi-layered structure (e.g., wherein the structure is a tile) is back molding. Initially, the first layer is introduced into the mold by using a method such as injection molding or compression molding forming a sheet or a film. The first layer is derived from the milled composition comprising at least one pigment. The first layered is cooled slightly and the suctioned on one side of the first layer using vacuum. On the opposite side, the milled composition not comprising at least one pigment is injected at high-pressure to fill the entire mold. This method may fuse the two layers having two different colors together. The multi-layered structure may be removed from the mold and trimmed. The structure may comprise a texture and/or sharp edges.

Generally, the milled composition with or without at least one pigment is heated and may be conducted at a temperature may range from about 150° C. to 250° C. to melt the powder. In various embodiments, the temperature of heating the powder of the pigmented or unpigmented recycled polymer powder composition may range from about 150° C. to about 250° C., from about 150° C. to about 170° C., from about 170° C. to about 190° C., from about 190° C. to about 210° C., from about 210° C. to about 230° C. or from about 230° C. to about 250° C. In one embodiment, the temperature of heating the compounded mixture may range from about 180° C. to 240° C.

In general, the molding utilizes a holding pressure from about 500 bar to 1500 bar. In various embodiments, the molding utilizes a holding pressure from about 500 bar to about 1500 bar, from about 500 bar to about 750 bar, from about 750 bar to about 1000 bar, from about 1000 bar to about 1250 bar, or from about 1250 bar to about 1500 bar.

Generally, the mold may use a clamping force from about 50 kilonewtons or higher. In various embodiments, the mold may use a clamping force from about 50 kN or higher, 100 kN or higher, 200 kN or higher, 500 kN or higher, or 100 k or higher.

Molds

The molds useful in preparing the tile or multi-layered tile may be made of various materials. Non-limiting examples of materials may be metals, metal alloys, clays, etc. such as steel, stainless steel, Hastelloy, carbon steel, aluminum, brass, etc., ceramics, etc. The primary aspect of the molds useful in preparing the sheet is that the mold may withstand the compressibility, the heat resistance, the pressure, and do not leach any materials such as metals from the mold to the recycled polymer sheet.

The mold may be of any dimension (including length, width, and thickness) and shape. Generally, for tiles, the thickness of the mold ranges from about 1 mm to about 10 mm, from about 3 mm to about 10 mm, from about 5 mm to about 10 mm, or from about 7 mm to about 10 mm. In various embodiments, the thickness of the mold may range from about 5 mm to about 10 mm, from about 5 mm to about 6 mm, from about 6 mm to about 7 mm, from about 7 mm to about 8 mm, from about 8 mm to about 9 mm, or about 9 mm to about 10 mm. In one embodiment, the thickness of the mold may range from about 7 mm to about 9 mm.

Coating

The tile composition may further comprise a coating. Various coatings are known in the art and described above.

In order to efficiently apply the coating, the composition comprising a tile is pre-treated using a corona, a plasma, or a flame. This treatment prepares the surface for the coating. Numerous methods are known in the art to apply the coating such as UV excimer technology, roll coating, dip coating, spray coating, or a combination thereof.

Articles

A wide variety of articles may be prepared by the tile composition and methods disclosed above. The articles, such as floor tiles, wall tiles, or decorative tiles may be of various dimensions and may be used in residential and commercial applications. The article may also be a countertop, a cabinet, a cabinet door, drinkware, etc.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.” As used herein, the terms “a,” “an,” and “the” are understood to encompass the plural as well as the singular. Thus, the term “a mixture thereof” also relates to “mixtures thereof” and the term “a component” also refers to “components.”

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/m L” should also be understood to provide support for the range of “50 mg/mL to 80 mg/m L”

In this disclosure, “comprises,” “comprising,” “containing,” and “having” and the like may mean “includes,” “including,” and the like, and are generally interpreted to be open ended terms. The terms “consisting of” or “consists of” are closed terms, and include only the components, structures, steps, or the like specifically listed in conjunction with such terms. “Consisting essentially of” or “consists essentially of” have the meaning of closed terms, with the exception of allowing a few more components.

The present disclosure provides inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims or may be learned by the practice of the principles set forth herein.

As various changes could be made in the above-described methods without departing from the scope of the invention, it is intended that all matter contained in the above description and in the examples given below, shall be interpreted as illustrative and not in a limiting sense.

### EXAMPLES

The following materials were utilized in the examples below. Recycled high density polyethylene and recycled polypropylene was obtained from numerous polymer manufacturing sources. Magnifin H5-GV and Safire 400 were obtained from Huber Materials and used without further purification. Adin Clay 20 was obtained from Tolsa and used without further purification. Chimassorb 2020, Chimassorb 81, Unival 4050, Ingracycle 30G were sourced from BASF and used without further purification. IncroMold K was sourced from Croda and used without further purification.

### Example 1: Preparation of HDPE Floor Tile

The following composition comprising a tile using a HDPE recycled polymer was prepared according to the components noted in Table 1.

TABLE 1
Components of HDPE Floor Tile

| | Weight |
|---|---|
| | Percentages |
| Component | (wt. % |
| recycled HDPE | 50-80% |
| Magnifin H5-GV | 30-40% |
| Adins Clay 20 | 1-5% |
| Safire 400 | 1-3% |
| Chimassorb 2020 | 0.10-3% |
| Chimassorb 81 | 0.10-3% |
| Irgacycle 30G | 0.10-3% |
| IncroMold K | 0.10-3% |

Note:
The above components for preparing HDPE floor tiles comprise 0 wt. % of virgin polymer.

The components in Table 1 above were mixed using mechanical mixing and then compounded using a commercial compounder. The compounded mixture was heated to a temperature from 170° C., extruded, and milled into a mixture of micropellets (250 micron to 1 mm), pellets (2 mm to 5 mm), and/or a powder (200 microns or less).

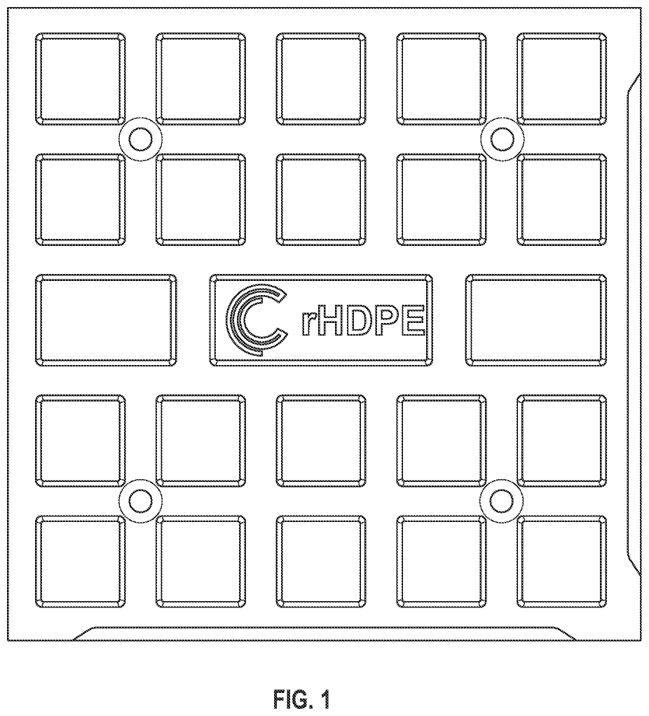

The powder was introduced into an aluminum mold by injection molding. The mold was cooled gently, and the industrial was prepared. FIG. 1 shows a color photograph of the HDPE floor tile produced by this process.

### Example 2: Preparation of a Wall LDPE Tile

The following composition comprising a tile using a LDPE recycled polymer was prepared according to the components noted in Table 2.

TABLE 2
Components of LDPE Floor Tile

| | Weight |
|---|---|
| | Percentages |
| Component | (wt. %) |
| recycled LDPE | 50-80% |
| Magnifin H5-GV | 30-40% |
| Adins Clay 20 | 1-5% |
| Safire 400 | 1-3% |
| Chimassorb 2020 | 0.10-3% |
| Chimassorb 81 | 0.10-3% |
| Irgacycle 30G | 0.10-3% |
| IncroMold K | 0.10-3% |

Note:
The above components for preparing LDPE floor tiles comprise 0 wt. % of virgin polymer

The components in Table 2 above were mixed using mechanical mixing and then compounded using a commercial compounder. The compounded mixture was heated to a temperature from 150° C., extruded, and milled into a mixture of micropellets (250 micron to 1 mm), pellets (2 mm to 5 mm), and/or a powder (200 microns or less). The powder was introduced into a stainless-steel mold by compression molding. The mold was cooled gently, and the wall tile was prepared.

### Example 3: Preparation of Floor Tile Comprising Recycled PP

The following wall tile was prepared using recycled PP polymer according to the components noted in Table 3.

TABLE 3
Components of PP Floor Tile

| | Weight |
|---|---|
| Component | Percentages |
| recycled PP | 50-80% |
| Magnifin H5-GV | 30-40% |
| Adins Clay 20 | 1-5% |
| Safire 400 | 1-3% |
| Chimassorb 2020 | 0.10-3% |
| Univul 4050 | 0.10-3% |
| Chimassorb 81 | 0.10-3% |
| Irgacycle 30G | 0.10-3% |
| IncroMold K | 0.10-3% |

Note:
The above components for preparing PP floor tiles comprise 0 wt. % of virgin polymer

The components in Table 3 above were mixed using mechanical mixing and then compounded using a commercial compounder. The compounded mixture was heated to a temperature from 160° C., extruded into a mixture of micropellets (250 micron to 1 mm), pellets (2 mm to 5 mm), and a powder (600 microns or less), then using injection molding, the micropellets, pellets, and/or powder was introduced into a ceramic mold. Using compression molding, the wall tile was formed. The mold was cooled gently, and the tile was prepared.

### Example 4: Preparation of a HDPE Floor Tile with Two Different Colors

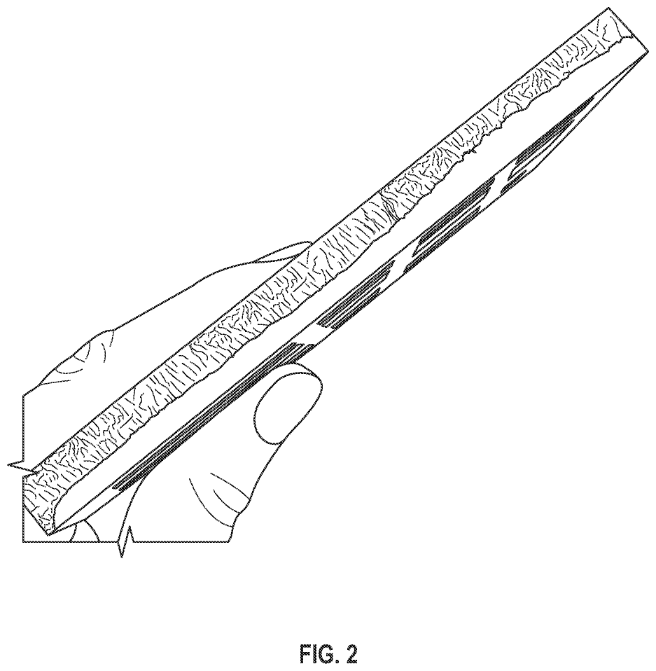

An 8″ wide, 8″ long, and 9 mm in depth aluminum mold was warmed to 75° C. The milled composition comprising at least one pigment is introduced into the mold. The mold was compressed. The mold was slightly cooled, and the compression removed forming a thin tile (film) of about 1 mm in thickness was formed. Vacuum suction was placed on one side of the sheet. On the other side, a milled composition not comprising at least one pigment was introduced and injected onto the opposite side of the suctioned side resulting in a different colored layer 7 mm thickness. After 10 minutes, the mold was cooled using a commercial chiller and removed, forming a floor tile. A coating was applied using spray coating. FIG. 2 is a color photograph demonstrating the HDPE Floor Tile with two different colors.

What is claimed is:

1. A tile composition comprising:
(a) at least about 40 weight % (wt. %) recycled polymer; and
(b) at least one additive including a mold releasing additive;
wherein the polymer comprises polypropylene (PP), polyethylene (PE), or a combination thereof and the composition comprises 0 wt. % of virgin polymer.

2. The composition of claim 1, wherein the tile includes a floor tile, a wall tile, or a decorative tile.

3. The composition of claim 1, wherein the at least 40 wt. % of recycled polymer comprises a polymer regrind.

4. The composition of claim 1, wherein the at least one additive comprises at least one flame retardant, at least one stabilizer additive, a stabilizer additive, or a combination thereof.

5. The composition of claim 1, further comprising at least one pigment compound.

6. The composition of claim 1, wherein the composition comprises from about 1 mm to about 5 mm thick sheet or film.

7. The composition of claim 1, wherein the composition comprises a compressed powder.

8. The composition of claim 1, wherein the composition comprises at least about 40% wt. % to about 95% wt. % of recycled polymer.

9. The composition of claim 1, wherein the composition comprises at least 40 wt. % to about 90 wt. % of recycled polymer.

10. The composition of claim 1, wherein the composition comprises at least 50 wt. % to about 90 wt. % of recycled polymer.

11. The composition of claim 1, wherein the composition comprises particles, particulates, pellets, and/or powder from about 1 mm to about 10 mm in size.

12. The composition of claim 1, wherein the composition comprises particles, particulates, pellets, and/or powder from about 1 mm to about 5 mm in size.

13. The composition of claim 1, wherein the composition comprises particles, particulates, pellets, and/or powder about 600 microns or less in size.

14. The composition of claim 1, wherein the composition comprises particles, particulates, pellets, and/or powder about 200 microns or less in size.

15. The composition of claim 1, wherein the recycled polymer comprises high density polyethylene (HDPE), low-density polyethylene (LDPE), polypropylene (PP), or a combination thereof and wherein the composition comprises 0 wt. % of virgin polymer.

16. The composition of claim 15, wherein the recycled polymer comprises from about 1 mm to about 5 mm of a shredded polymer.

17. The composition of claim 16, wherein the shredded polymer has a jagged-edged appearance.

18. The composition of claim 3, wherein the polymer regrind comprises from about 2 mm to about 5 mm hard, ball-shaped, or tube-shaped polymer.

19. The composition of claim 18, wherein the polymer regrind comprises pellets that are about 200 microns or less.

20. The composition of claim 1, comprising a surface tension of at least about 40 mN/m or higher.

21. The composition of claim 20, comprising a surface tension of at least about 45 mN/m or higher.

22. The composition of claim 21, comprising a surface tension of at least about 50 mN/m or higher.

23. The composition of claim 4, wherein the at least one flame retardant comprises about 0.1 wt. %% to about 50% wt. % of the composition.

24. The composition of claim 4, wherein at least one light stabilizer in the comprises from about 0.005 wt. % to about 10 wt. % of the composition.

25. The composition of claim 4, wherein the stabilizer additive comprises about 0.005 wt. % to about 5 wt. % of the composition.

26. The composition of claim 1, wherein the mold releasing additive comprises about 0.005 wt. % to about 5 wt. % by of the composition.

27. The composition of claim 4, wherein the stabilizer additive, the mold releasing additive, or a combination thereof comprises about 0.01 wt. % to about 8 wt. % of the composition.

28. The composition of claim 27, wherein the stabilizer additive, the mold releasing additive, or a combination thereof comprises about 0.10 wt. % to about 6 wt. % of the composition.

29. The composition of claim 1, wherein the at least one flame retardant, the at least one light stabilizer, stabilizer additive, the mold releasing additive, or a combination thereof comprises about 1 wt. % to about 70 wt. % of the composition.
